(19) United States
(12) Patent Application Publication
(10) Pub. No.: US 2004/0181529 A1
(43) Pub. Date: Sep. 16, 2004

(54) Method, system, and program for enabling access to device information

(75) Inventors: Daniel K. Hiltgen, Los Gatos, CA (US); Paul D. Von Behren, Boulder, CO (US)

Correspondence Address: KUDIRKA & JOBSE, LLP, ONE STATE STREET, SUITE 800, BOSTON, MA, 02109, US

(73) Assignee: Sun Microsystems, Inc.

(21) Appl. No.: 10/387,082

(22) Filed: Mar. 11, 2003

(51) Int. Cl. G06F 17/30; G06F 7/00

(52) U.S. Cl. 707/9

(57) ABSTRACT

Provided are a method, system, program, and data structures for enabling access to device information. At least one data object includes code providing a representation of elements conforming to a schema specifying details for managing components, wherein the at least one data object includes at least one representation of a device property value. A request for one data object is received and an output data object is generated including the elements from the requested data object and the at least one representation of the device property value. A determination is made of a device property value for the corresponding at least one representation of the device property value in the data object and the at least one determined device property value is included in the output data object. The output data object is returned in response to the request.

### BACKGROUND OF THE INVENTION

1. Field of the Invention

The present invention relates to a method, system, and program for enabling access to device information.

2. Description of the Related Art

The Web-Based Enterprise Management (WBEM) framework is a set of management and Internet standard technologies developed to provide a common set of protocols to enable the management of enterprise computing environments. The WBEM standard includes the Common Information Model (CIM), which provides a conceptual framework for interchanging information between management systems and applications. The CIM schema provides a set of object oriented classes with properties that are used to organize and access the information about the managed environment in a common format. One can construct a generalized management application using the CIM framework and components without needing to know or incorporate device specific or proprietary commands of the device being managed. Further details of the CIM model are described in publications from the Distributed Management Task Force (DMTF), including “Common Information Model (CIM) Specification”, Version 2.2, (Jul. 14, 1999) and “Understanding the Application Management Model”, Version 1.0 (May 17, 1998), which publications are incorporated herein by reference in their entirety.

To comply with the CIM architecture, a product must implement the CIM core and common schema classes to enable CIM clients to use standard CIM methods to access information about the product. This requires the product vendor to develop product (e.g., application , device, system, etc.) specific code that implements the CIM classes, referred to as a CIM provider, that provides access to the product information and configuration settings as specified in the CIM specification. The device vendor must write device specific code that in response to calls from methods defined in the CIM specification performs device specific operations to provide the requested information and configuration operations as defined in the CIM specification.

### SUMMARY OF THE DESCRIBED IMPLEMENTATIONS

Provided are a method, system, program, and data structures for enabling access to device information. At least one data object includes code providing a representation of elements conforming to a schema specifying details for managing components, wherein the at least one data object includes at least one representation of a device property value. A request for one data object is received and an output data object is generated including the elements from the requested data object and the at least one representation of the device property value. A determination is made of a device property value for the corresponding at least one representation of the device property value in the data object and the at least one determined device property value is included in the output data object. The output data object is returned in response to the request.

In further implementations, the data object code indicates a component for which the elements are generated, wherein a set of the elements are generated into the output data object for each instance of the indicated component in the device, and wherein determined device property values for one component are added in each generated set of the elements.

Yet further, the data object code may specify a condition, wherein the set of elements are generated for each instance of the indicated component that satisfies a specified condition.

Further provided are a method, system, and program for accessing device information from a device. A request is received for at least one property value for the device and a determination made of a data object in the device including the requested at least one property value. The determined data object is requested from the device and received. The received data object includes code providing a representation of elements conforming to a schema specifying details for managing components, and wherein the data object includes at least one device property value of the device. A response is generated to the received request including the representation of the elements and the at least one device property value from the data object corresponding to the at least one requested property value.

In certain implementations, the managed components may comprise network components, wherein the schema specifying details for managing the network components may comprise the Common Information Model (CIM) schema, and wherein the data objects may comprise Extensible Markup Language (XML) objects providing a representation of the CIM elements.

### BRIEF DESCRIPTION OF THE DRAWINGS

Referring now to the drawings in which like reference numbers represent corresponding parts throughout:

FIG. 1 illustrates a computing environment in accordance with implementations of the invention;

FIGS. 2 and 3 illustrate examples of a page including elements and property values in accordance with implementations of the invention;

FIG. 4 illustrates logic implemented in a component to request device information in accordance with implementations of the invention;

FIG. 5 illustrates logic implemented in a device to return device information in accordance with implementations of the invention; and

FIG. 6 illustrates an example of a computing architecture in which aspects of the inventions may be implemented.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

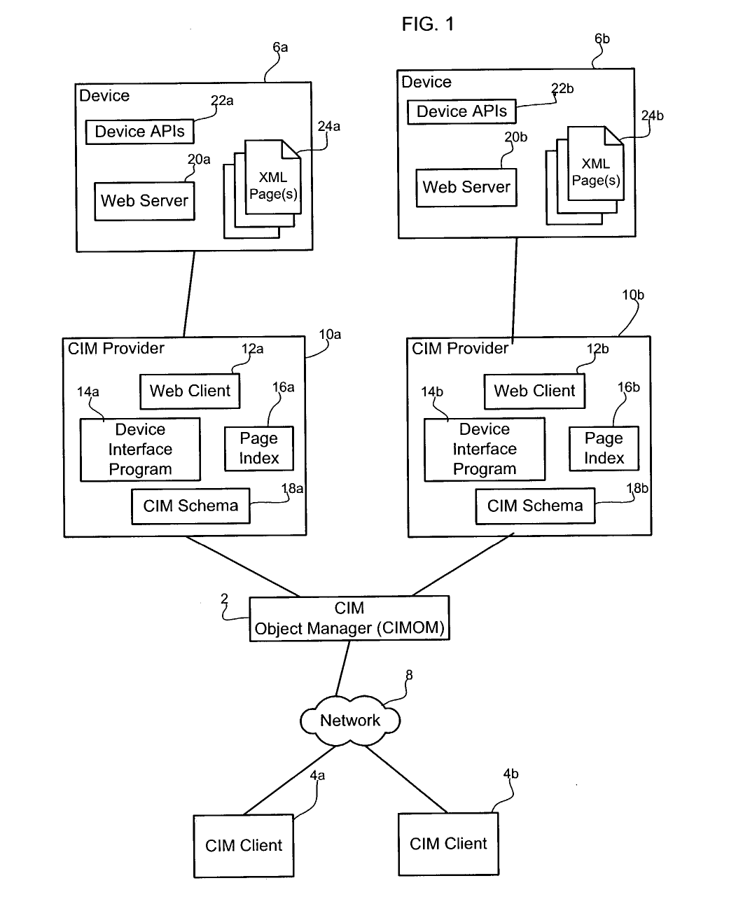

FIG. 1 illustrates a WBEM computing environment in which aspects of the invention are implemented. As discussed, the WBEM computing environment provides a framework to model, present for use, and decompose information on devices to management applications that are not aware of the particulars of the managed devices. The WBEM farmwork provides a consistent interface to management applications across devices. A CIM Object Manager (CIMOM) 2 receives requests from CIM clients 4a and 4b for information on devices 6a and 6b. The CIM clients 4a and 4b may communicate with the CIMOM 2 over a network 8. The CIMOM 2 implements, in a manner known in the art: a transport mechanism (e.g., TCP) and application protocol (e.g., HTTP) to communicate with the CIM clients 4a and 4b. The clients 4a and 4b may utilize an HTML browser for communication; encoding and decoding of messages (e.g., CIM-XML); dispatching of messages to providers 10a, 10b . . . 10n and/or a CIM repository (not shown); and an aggregation of results from multiple CIM providers 10a, 10b . . . 10n to return in a single response, e.g., single HTML page, to the requesting client 4a, 4b. The CIMOM 2 processes the requests from the clients 4a and 4b and then interfaces with the CIM providers 10a, 10b, where the CIM providers 10a, 10b in turn obtain the requested device specific information or perform the device related operations, and return any obtained information to the CIMOM 2 to return to the CIM clients 4a, 4b. The CIMOM 2 and CIM providers 10a, 10b may run in the same address space, such as the same Java Virtual Machine (JVM). (Java is a trademark of Sun Microsystems, Inc.)

The CIM providers 10a and 10b provide information about a specific type of device 6a and 6b, where a type of device comprises a specific model of a device, such as storage device, network device, software program, logical device, etc. Multiple providers 10a, 10b may be utilized to provide access to different types of information and controls for a device, or to provide information for specific components of a device, e.g., the hard disk drives, controller, network card, etc., within a storage server. Each CIM provider 10a, 10b includes a web client 12a, 12b capable of issuing document requests to a web server, such as web servers 20a, 20b in devices 6a, 6b. In certain implementations, the web clients 12a, 12b may comprise Hypertext Transport Protocol (HTTP) clients capable of issuing HTTP GET requests to retrieve documents from web servers 20a, 20b operating as HTTP servers. Each CIM provider 10a, 10b further includes a device interface program 14a, 14b to generate requests for device data in XML pages 24a, 24b at the device 6a, 6b identified in the page index 16a, 16b through the web clients 12a, 12b. The CIM Providers 10a, 10b further implement the CIM schema 18a, 18b by implementing instances of the core CIM classes to return requests to the CIMOM 2.

Each device 6a, 6b may include an embedded web server 20a, 20b to process document requests from the CIM providers 10a, 10b, one or more XML pages 22a, 22b to return to the CIM providers 10a, 10b in response to GET requests, and device Application Programming Interfaces (APIs) 24a and 24b to access information from the managed resource 6a and 6b.

The network 8 may comprise any network system known in the art, such as a Local Area Network (LAN), Storage Area Network (SAN), Wide Area Network (WAN), the Internet, an Intranet, etc. The devices 6a and 6b may comprise a software application, such as database program, utility program, operating system, etc., or a hardware device, such as a storage device, printer, network appliance, virtualization device, Internet appliance, or any other device known in the art capable of being electronically queried for information. To access information on the devices 6a and 6b, the CIM clients 4a and 4b would issue information requests conforming to the CIM specification and CIM indication classes to the CIMOM 2. The CIM clients 4a and 4b, CIMOM 2, CIM providers 10a, 10b . . . 10n, and devices 6a, 6b may be implemented on different computing devices or execute on the same computing device. The computing device in which the components are implemented may comprise any type of computing device known in the art, such as a server, workstation, desktop computer, portable computer, hand held computer, telephony device, network appliance, etc. In certain implementations, the CIM providers 10a, 10b and CIMOM 2 are implemented on a separate server class computer in order to handle information requests from various CIM clients 4a, 4b over the network 8.

There may be any number of clients 4a, 4b, CIM providers 10a, 10b and devices 6a, 6b, including more or less than shown in FIG. 1. Further, one CIM provider may interface with one or more devices 6a, 6b. Further, the devices may comprise different types of devices and devices from different vendors.

In certain implementations, CIM representations of device properties are generated at the device and returned to the CIM Provider. The CIM provider in turn returns those CIM representations received and generated from the device to the CIMOM that correspond to the device properties requested by the CIM client. With such implementations, the device developer does not have to create interface code to translate property information received from the device into CIM representations because the CIM representations are generated at the device. In further implementations, the device maintains XML documents including the CIM representations. In response to a request from the CIM provider, a component at the device, such as a web server, adds actual device property values for the CIM representations into the XML document to return to the CIM provider.

Each vendor may provide the CIM provider 10a, 10b, a web server 20a, 20b and XML pages 22a, 22b including CIM representations to enable communication of CIM related data to the CIM providers 10a, 10b. The CIM Provider 10a, 10b would then extract the CIM representations from the received XML document that correspond to the CIM properties requested by the clients 4a, 4b, and return the extracted CIM representations to the CIMOM 2.

In certain implementations, the XML pages 24a, 24b in the devices 6a, 6b provide a representation of the CIM classes for that device 6a, 6b in the XML format. The XML pages 24a, 24b will define CIM classes, properties for the class that provide information on a class, qualifiers for a property that provide additional information about the class and properties, such as metadata, and values for the properties. The values for a property can distinguish instances of a class. For example, a single storage device may have multiple instances of field replaceable units, disks, volumes, etc., thus multiple instances of a class. In described implementations, the XML pages 24a, 24b maintained at the device may comprise well-formed documents expressing CIM declarations in compliance with the CIM schema implemented for that device, including all the CIM schema elements that are defined for that device type 6a, 6b, including classes, properties, and qualifiers. The XML pages 24a, 24b maintained at the devices 6a, 6b may define CIM elements using the CIM XML schema vocabulary described in the publication “Specification for the Representation of CIM in XML”, ver. 2.1, doc. name “DSP0201” (Copyright DMTF May, 2001), which publication is incorporated herein by reference in its entirety. This document provides a mapping of CIM elements to XML elements to implement the CIM schema within an XML document.

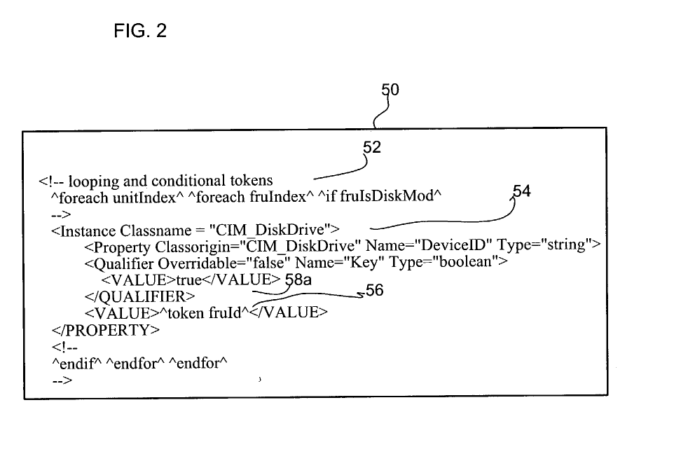

FIG. 2 illustrates an example 50 of the content of the XML pages 24a, 24b. The XML page 50 includes a looping and conditional code statement 52 that is device specific, and indicates the components for which the CIM elements are generated. In the example of FIG. 2, the looping and conditional statement 52 generates the CIM elements 54 for each field replaceable unit (FRU), referred to as the “fruINDEX” in the statement 52, within each controller, referred to as the “unitINDEX”, in the looping and conditional statement 52. In this way, CIM element information is generated for all units (controllers) for the storage device, e.g., RAID array, and for each FRU within each controller. Further, the statement 52 includes a conditional statement inquiring whether each FRU is a disk drive (diskmod), such that the CIM element information is only generated for each component located within the nested loop that satisfies the condition, e.g., is a disk drive in the example of FIG. 2. Any number of loops and conditional statements may be used depending on the number of component types within the device and conditions for which the information is to be generated.

In FIG. 2, the CIM elements 54 generated provides the instance name, which is the device name of “DiskDrive”, and property information for the instance, such as the identifier (“DeviceID”) of the device, qualifier metadata for the instance, and the FRU ID. As shown in FIG. 2, in certain implementations, the input XML page 50 includes a token 56 in which the actual device FRU ID for the FRU located during the execution of the looping and conditional statement 52 is relocated. The token 56 causes the device 6a, 6b to use device APIs 22a, 22b to gather the information corresponding to the component represented by the token 56, such as an IP address, device or component identifier, status, state, etc. The gathered information for the token 56 is then substituted into the output XML page 70 for the token 56 statement to return. In this way, the XML page 50 includes CIM elements and classes mapped to elements in the XML format including actual values from the device 6a, 6b.

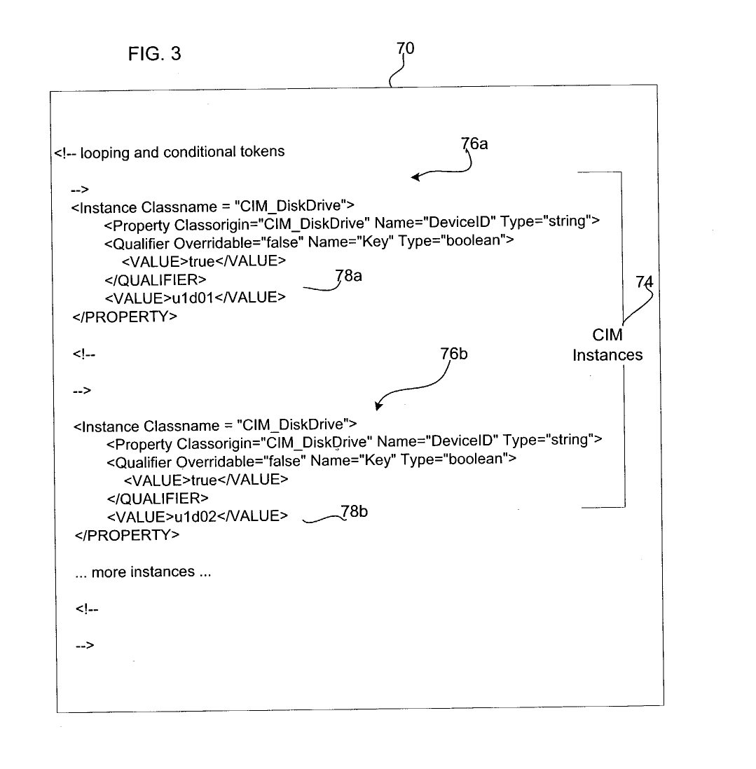

When a CIM provider 10a, 10b requests an XML page 24a, 24b through the web client 12a, 12b, the web server 20a, 20b would process all the tokens within the XML page 50 and execute device APIs 22a, 22b associated with the tokens 58a, 58b to obtain the device 6a, 6b value associated with the token, which may define the configuration of device hardware or a logical component, status, state, etc., and substitute the token with the value obtained from the device. FIG. 3 illustrates an output XML page 70 having each CIM instances 74 output generated during execution of the looping and conditional statement 52. Each generated CIM instance 76a, 76b includes the actual device values 78a, 78b, which in the example are FRU identifiers (“u1d01” and “u1d02”), substituted for the token 56 defined in the input XML page 50 (FIG. 2). The generated output XML page 70 does not include the looping and conditional statement 52, which is included in comments in the output XML page 70.

In certain implementations, the device 6a, 6b may maintain only one XML page that includes all the CIM instances defined for that device type. In such implementations, the page index 16a, 16b maintained by the CIM provider 10a, 10b would only indicate that single XML page 24a, 24b to request, which includes all the CIM instances and property values. Alternatively, the device 6a, 6b may maintain multiple XML pages 24a,2 4b, where each page provides a set of one or more non-overlapping CIM elements and property values. In this way, the CIM elements defined for that device may be dispersed throughout multiple XML pages. In such implementations where the CIM properties provided by that device 6a, 6b are found in multiple XML pages, the page index 16a, 16b may provide a mapping indicating the XML page including the device value for each CIM property value. Using multiple pages reduces the amount of information transmitted between the CIM provider 10a, 10b and device 6a, 6b to reduce network traffic, thereby reducing the download time.

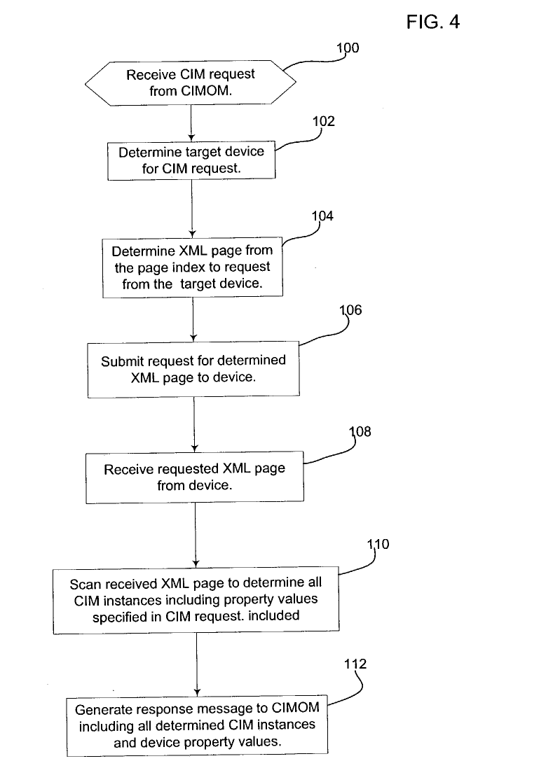

FIG. 4 illustrates operations performed in the CIM provider 10a, 10b to handle a CIM request for one or more property values originated at a CIM client 4a, 4b. Upon receiving (at block 100) the CIM request from the CIMOM 2, the device interface program 14a, 14b determines (at block 102) the target device 6a, 6b subject to the CIM request and determines (at block 104) the XML page to request from the page index 16a, 16b from the CIM device 6a, 6b. In implementations where all the CIM property values are transmitted through a single XML page, then the page index 16a, 16b would indicate only a single XML page to request, such as a single Universal Resource Locator (URL). In implementations where CIM property values and instances are located in multiple XML pages at the device 6a, 6b, the page index 16a, 16b would indicate the URL of the XML page 24a, 24b that includes the requested property values. The device interface program 14a, 14b would then submit (at block 106) through the web client 12a, 12b a request for the determined XML page including the requested property values, such as an HTTP GET request for the URL of the XML page indicated in the page index 16a, 16b. If the page index 16a, 16b indicates that the property values included in the CIM request are contained in multiple XML pages 24a, 24b at the devices 6a, 6b, then the device interface program 14a, 14b would submit GET requests to all the determined URLs.

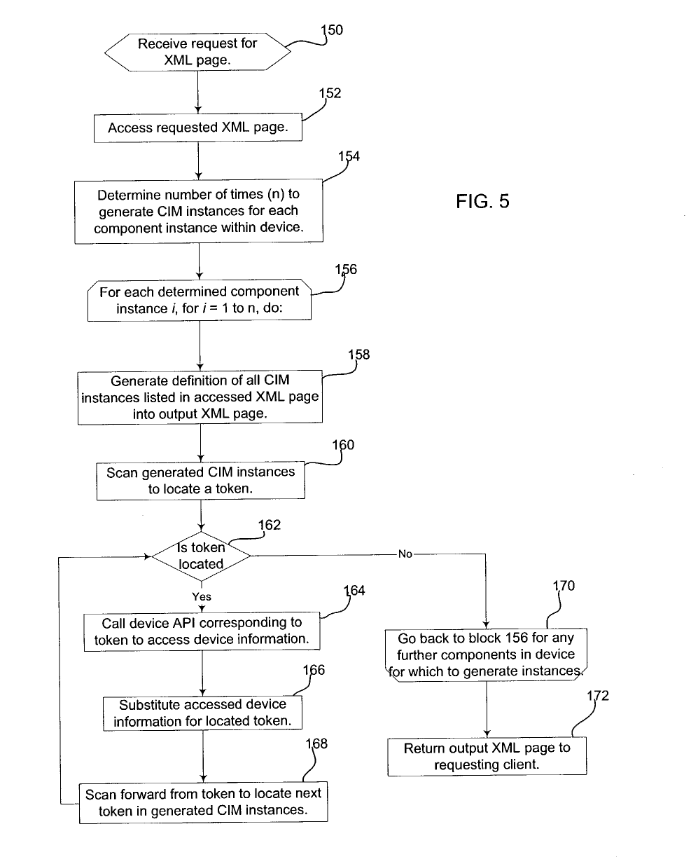

FIG. 5 illustrates logic implemented in the device 6a, 6b web server 20a, 20b to respond to requests from the CIM providers 10a, 10b for XML pages 24a, 24b. Upon receiving (at block 150) a request for an XML page 24a, 24b, the web server 20a, 20b accesses (at block 152) the requested XML page 24a, 24b, such as input XML page 50 (FIG. 2). Based on the looping and conditional statement 52, the web server 20a, 20b determines (at block 154) the device 6a, 6b component for which the CIM instances 54 will be generated and the number of instances (n) of such determined component, such that the CIM instances 54 are generated n times into the output XML page 70 (FIG. 3), where n is any integer value. For instance, if the program execution statement 52 indicates the field replaceable unit (FRU) component (or any other hardware or logical component within the device 6a, 6b), then the CIM instances 54 will be generated with property values for each FRU (or other specified component) within the device 6a, 6b. If the statement 52 includes one or more conditional statements, then the CIM instance 54 will be generated for each FRU (or other specified component) that satisfies the conditions indicated in the conditional component of the statement 52. Alternatively, if the looping and conditional statement 52 does not identify one or more components for which CIM instances 54 will be generated, then the CIM instances 54 may only be generated once for the device 6a, 6b. A loop is then performed at blocks 156 through 170 for each determined instance of the component that satisfies any conditional statement for which the CIM instances 54 are to be generated.

For each determined component instance i satisfying any specified conditions, the web server 20a, 20b generates (at block 158) the CIM instances 54, including defined properties, qualifiers, and values of the CIM instances, into the output XML page 70 (FIG. 3). If previous sets of CIM instances 76a were generated, then the current generated set of CIM instances 76b would follow any previously generated sets of CIM instances 76a. The web server 20a, 20b then scans (at block 160) the generated CIM instances 76a, 76b to locate any tokens 78a, 78b. If (at block 162) a token 78a, 78b is located, then the web server 20a, 20b calls (at block 164) the device API 22a, 22b corresponding to the located token 78a, 78b to execute within the device 6a, 6b to fetch the requested device property value. The web server 20a, 20b then substitutes (at block 166) the accessed device data for the token 78a, 78b so that the actual device values for the property are added to the output XML page 70 (FIG. 3). The web server 20a, 20b then scans (at block 168) forward through the generated CIM instances 76a, 76b to locate a next token 78a, 78b. If (at block 162) a further token is not located following the first scan (at block 160) or a subsequent scan (at block 168), then control proceeds back (at block 170) to block 156 to generate CIM instances 74 into the output XML page 70 for any further component instances within the device 6a, 6b. After generating CIM instance sets 74 and substituting device values for all components for which information is gathered within the device 6a, 6b, the web server 20a, 20b adds any final code to the output XML page 70 and returns (at block 172) the generated output XML page 70 to the CIM provider 10a, 10b which initiated the request for the page 24a, 24b. In additional implementations, the tokens can be substituted after generating all the CIM instance sets 76a, 76b into the output XML page 70, or after generating each CIM instance 76a, 76b, such as shown in FIG. 5.

With respect to FIG. 4, when the CIM provider 10a, 10b receives (at block 108) the requested XML page 70, the device interface program 14a, 14b scans (at block 110) the received XML page 70 to determine all CIM instances including property values requested in the received CIM request. The device interface program 14a, 14b then generates (at block 112) a response message to send to the CIMOM 2 including all determined CIM instances and device property values to return to the CIM client 4a, 4b. In certain implementations, the CIM provider 10a, 10b may convert the CIM elements extracted from the received XML page 70 into a Java representation instance to return to the CIMOM in a manner known in the art.

With the described implementations, the CIM provider 10a, 10b generates the response to the CIMOM from the CIM representations, i.e., instances and property values for that device 6a, 6b, included in the XML output page 70 received from the device 6a, 6b. In this way, the CIM provider 10a, 10b does not have to translate the data from the device 6a, 6b into a CIM schema format because the device 6a, 6b returns the data in XML representations of the CIM instances and property values for that device 6a, 6b. With the described implementations, the CIM provider 10a, 10b need only use standard communication interfaces, such as HTTP, to communicate with the device 6a, 6b, thereby limiting the need for the developer to create proprietary interface code to enable communication between the CIM provider and device and to enable the CIM provider to convert data received from the device to a CIM response for the CIMOM. Further, with the described implementations, the device uses a standard embedded web server 20a, 20b to return requested pages to the CIM provider and substitute device values for tokens in the XML pages, where the XML pages just happen to include CIM instances and expressions.

Further, with the described implementations, device developers can re-use the CIM provider code for different devices that return the XML representation of the CIM instances in the same format because the CIM provider receives the output from the device as an XML representation of the CIM elements, where the XML representations and CIM instances are not device specific, but the specific property values for the CIM instances may differ for each device.

The described techniques for enabling interaction and management of a device may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor complex. The code in which embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The above described implementations concerned the CIM architecture to allow CIM clients access to device specific information. The described implementations may be applied to component architectures other than CIM, where an interchange protocol is provided to enable clients to access information from different vendor devices.

In the described implementations, the device returned pages in an XML format including a representation of the CIM instances. In alternative implementations, the CIM instances may be encoded in data objects in other formats, such as HTML, ASCI, etc.

In further implementations, the CIM providers 10a, 10b may buffer CIM property values received in the XML pages from the device in memory so that future CIM requests for property values may be returned from the buffered property values without going back to the device to request the XML page including property values. The CIM provider may periodically retrieve the XML page(s) from the device 6a, 6b to refresh the property values maintained in the buffer that are available to return to CIM requests.

In the described implementations, the devices 6a, 6b for which property values are accessed may comprise an application program, hardware device or a logical device.

The above described implementations organized the program code into an object oriented class structure. In alternative implementations, the program operations described herein may be implemented in methods in class architectures other than those described herein. Further, the program operations may be implemented in non-object oriented programming code.

In described implementations, the various components, such as the devices, CIM providers, CIMOM, and CIM clients communicate over a network, such as a LAN, SAN, etc. In alternative implementations, any number of these components may communicate over alternative interfaces, such as a bus interface within a system.

The logic of FIGS. 4 and 5 describes specific operations occurring in a particular order. In alternative implementations, certain of the logic operations may be performed in a different order, modified or removed. Morever, steps may be added to the above described logic and still conform to the described implementations. Further, operations described herein may occur sequentially or certain operations may be processed in parallel. Yet further, the described operations may be performed by a single processing unit or by distributed processing units.

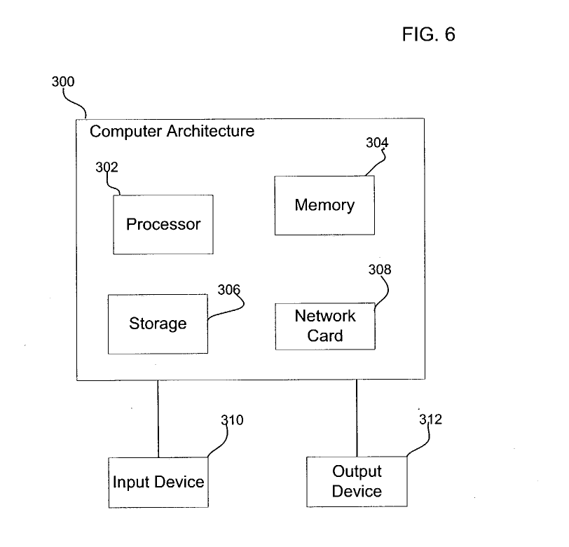

FIG. 6 illustrates one implementation of the architecture of the computer systems in which the described components, such as CIM providers 10a, 10b, devices 6a, 6b, CIMOM 2, CIM clients 4a, 4b. These systems may implement a computer architecture 300 having a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network. The program components described in FIG. 1 may be implemented in a single computer system or in distributed computer systems that communicate using a distributed computing protocol, such as Jini, Remote Method Invocation (RMI), HTTP, etc.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for enabling access to device information, comprising:
maintaining at least one data object including code providing a representation of elements conforming to a schema specifying details for managing components, wherein the at least one data object includes at least one representation of a device property value;
receiving a request for one data object;
generating an output data object including the elements from the requested data object and the at least one representation of the device property value;
determining a device property value for the corresponding at least one representation of the device property value in the data object;
including the at least one determined device property value in the output data object; and
returning the output data object in response to the request.

2. The method of claim 1, wherein including the at least one determined device property value comprises substituting each determined device property value for the representation of the device property value in the output data object.

3. The method of claim 1, wherein determining the device property value comprises calling a device application program interface (API) to execute in the device to determine the at least one device property value represented in the data object.

4. The method of claim 1, wherein the data object code indicates a component for which the elements are generated, wherein a set of the elements are generated into the output data object for each instance of the indicated component in the device, and wherein determined device property values for one component are added in each generated set of the elements.

5. The method of claim 4, wherein the data object code specifies a condition, wherein the set of elements are generated for each instance of the indicated component that satisfies a specified condition.

6. The method of claim 1, wherein a plurality of data objects include different sets of elements and property values.

7. The method of claim 1, wherein the managed components comprise network components, wherein the schema specifying details for managing components comprises the Common Information Model (CIM) schema, and wherein the at least one data object comprises an Extensible Markup Language (XML) object providing a representation of the CIM elements.

8. The method of claim 7, wherein the request is received from a CIM provider.

9. The method of claim 1, wherein the device is a member of the set of devices including a storage device, software application, hardware component, and logical device.

10. A method for accessing device information from a device, comprising:
receiving a request for at least one property value for the device;
determining a data object in the device including the requested at least one property value;
requesting the determined data object from the device;
receiving the requested data object, wherein the data object includes code providing a representation of elements conforming to a schema specifying details for managing components, and wherein the data object includes at least one device property value of the device; and
generating a response to the received request including the representation of the elements and the at least one device property value from the data object corresponding to the at least one requested property value.

11. The method of claim 9, wherein determining the data object in the device including the requested at least one property value comprises determining at least one of a plurality of data objects including property values that include the requested at least one property value.

12. The method of claim 11, wherein an index provides an association of device property values to data objects, wherein determining the data object that includes the requested at least one property value comprises processing the index to determine the at least one data object associated with the requested at least one property value.

13. The method of claim 10, further comprising:
buffering data objects returned from the device, wherein generated responses to subsequent requests for at least one property value include at least one device property value from the buffered data object corresponding to the requested property value.

14. The method of claim 10, wherein the managed components comprise network components, wherein the schema specifying details for managing the network components comprises the Common Information Model (CIM) schema, and wherein the data object comprise Extensible Markup Language (XML) objects providing a representation of the CIM elements.

15. The method of claim 10, wherein the steps of receiving the request, determining and requesting the data object, receiving the requested data object and generating the response are performed by a CIM provider, and wherein the request for the at least one property value is received from a CIM Object Manager (CIMOM).

16. A system for enabling access to device information, comprising:
a computer readable medium including at least one data object including code providing a representation of elements conforming to a schema specifying details for managing components, wherein the at least one data object includes at least one representation of a device property value;
means for receiving a request for one data object;
means for generating an output data object including the elements from the requested data object and the at least one representation of the device property value;
means for determining a device property value for the corresponding at least one representation of the device property value in the data object;
means for including the at least one determined device property value in the output data object; and
means for returning the output data object in response to the request.

17. The system of claim 16, wherein the means for including the at least one determined device property value substitutes each determined device property value for the representation of the device property value in the output data object.

18. The system of claim 16, wherein the data object code indicates a component for which the elements are generated, wherein a set of the elements are generated into the output data object for each instance of the indicated component in the device, and wherein determined device property values for one component are added in each generated set of the elements.

19. The system of claim 18, wherein the data object code specifies a condition, wherein the set of elements are generated for each instance of the indicated component that satisfies a specified condition.

20. A system for accessing device information from a device, comprising:
means for receiving a request for at least one property value for the device;
means for determining a data object in the device including the requested at least one property value;
means for requesting the determined data object from the device;
means for receiving the requested data object, wherein the data object includes code providing a representation of elements conforming to a schema specifying details for managing components, and wherein the data object includes at least one device property value of the device; and
means for generating a response to the received request including the representation of the elements and the at least one device property value from the data object corresponding to the at least one requested property value.

21. The system of claim 16, further comprising:
a computer readable medium including an index, wherein the index provides an association of device property values to data objects, wherein the means for determining the data object that includes the requested at least one property value comprises processing the index to determine at least one data object associated with the requested at least one property value.

22. The system of claim 16, further comprising:
means for buffering data objects returned from the device, wherein generated responses to subsequent requests for at least one property value include at least one device property value from the buffered data object corresponding to the requested property value.

23. An article of manufacture for enabling access to device information, wherein the article of manufacture causes operations to be performed, the operations comprising:
maintaining at least one data object including code providing a representation of elements conforming to a schema specifying details for managing components, wherein the at least one data object includes at least one representation of a device property value;
receiving a request for one data object;
generating an output data object including the elements from the requested data object and the at least one representation of the device property value;
determining a device property value for the corresponding at least one representation of the device property value in the data object;
including the at least one determined device property value in the output data object; and
returning the output data object in response to the request.

24. The article of manufacture of claim 23, wherein including the at least one determined device property value comprises substituting each determined device property value for the representation of the device property value in the output data object.

25. The article of manufacture of claim 23, wherein determining the device property value comprises calling a device application program interface (API) to execute in the device to determine the at least one device property value represented in the data object.

26. The article of manufacture of claim 23, wherein the data object code indicates a component for which the elements are generated, wherein a set of the elements are generated into the output data object for each instance of the indicated component in the device, and wherein determined device property values for one component are added in each generated set of the elements.

27. The article of manufacture of claim 26, wherein the set of elements are generated for each instance of the indicated component that satisfies a specified condition.

28. The article of manufacture of claim 23, wherein a plurality of data objects include different sets of elements and property values.

29. The article of manufacture of claim 23, wherein the managed components comprise network components, wherein the schema specifying details for managing components comprises the Common Information Model (CIM) schema, and wherein the at least one data object comprises an Extensible Markup Language (XML) object providing a representation of the CIM elements.

30. The article of manufacture of claim 29, wherein the request is received from a CIM provider.

31. The article of manufacture of claim 23, wherein the device is a member of the set of devices including a storage device, software application, hardware component, and logical device.

32. An article of manufacture for accessing device information from a device, wherein the article of manufacture causes operations to be performed, the operations comprising:
receiving a request for at least one property value for the device;
determining a data object in the device including the requested at least one property value;
requesting the determined data object from the device;
receiving the requested data object, wherein the data object includes code providing a representation of elements conforming to a schema specifying details for managing components, and wherein the data object includes at least one device property value of the device; and
generating a response to the received request including the representation of the elements and the at least one device property value from the data object corresponding to the at least one requested property value.

33. The article of manufacture of claim 32, wherein determining the data object in the device including the requested at least one property value comprises determining at least one of a plurality of data objects including property values that include the requested at least one property value.

34. The article of manufacture of claim 33, wherein an index provides an association of device property values to data objects, wherein determining the data object that includes the requested at least one property value comprises processing the index to determine the at least one data object associated with the requested at least one property value.

35. The article of manufacture of claim 32, further comprising:
buffering data objects returned from the device, wherein generated responses to subsequent requests for at least one property value include at least one device property value from the buffered data object corresponding to the requested property value.

36. The article of manufacture of claim 32, wherein the managed components comprise network components, wherein the schema specifying details for managing the network components comprises the Common Information Model (CIM) schema, and wherein the data object comprise Extensible Markup Language (XML) objects providing a representation of the CIM elements.

37. The article of manufacture of claim 32, wherein the steps of receiving the request, determining and requesting the data object, receiving the requested data object and generating the response are performed by a CIM provider, and wherein the request for the at least one property value is received from a CIM Object Manager (CIMOM).

38. A computer readable medium, including:
at least one data object including code providing a representation of elements conforming to a schema specifying details for managing components, wherein the at least one data object includes at least one representation of a device property value; and
an output data object including the elements from the requested data object and the at least one representation of the device property value, wherein a determination is made of a device property value for the corresponding at least one representation of the device property value in the data object and include the at least one determined device property value in the output data object.

39. The computer readable medium of claim 38, wherein the data object code indicates a component for which the elements are generated, wherein a set of the elements are generated into the output data object for each instance of the indicated component in the device, and wherein determined device property values for one component are added in each generated set of the elements.

40. The computer readable medium of claim 39, wherein the data object code specifies a condition, wherein the set of elements are generated for each instance of the indicated component that satisfies the specified condition.

41. The computer readable medium of claim 38, wherein the managed components comprise network components, wherein the schema specifying details for managing components comprises the Common Information Model (CIM) schema, and wherein the at least one data object comprises an Extensible Markup Language (XML) object providing a representation of the CIM elements.
